(19) United States
(12) Patent Application Publication
(10) Pub. No.: US 2017/0029607 A1
(43) Pub. Date: Feb. 2, 2017

(54) HALOGEN-FREE FLAME RETARDANT MATERIAL FOR DATA COMMUNICATION CABLES

(71) Applicant: NEXANS, Paris (FR)

(72) Inventors: Travis Getzie, Lancaster, PA (US); Pranabes Pramanik, Downingtown, PA (US)

(21) Appl. No.: 14/755,601

(22) Filed: Jun. 30, 2015

(51) Int. Cl. C08L 23/02; C09K 21/06; C09K 21/12

(52) U.S. Cl. CPC C08L 23/02; C09K 21/12; C09K 21/06; C08L 2207/04; C08L 2201/02

(57) ABSTRACT

A material is provided for insulation within a data communication cable, the material having a base polymer, a phosphorus containing additive, an organo-titantate additive, and silica material (fumed, precipitated, etc).

### BACKGROUND

Field of the Invention

The present arrangement is directed to an insulation material. More particularly, the present arrangement is directed to a halogen-free insulation material for insulating conductors in a data communication cable.

Description of Related Art

Communication cables come in wide variety of shapes and sizes depending on the application. One type of communication cable is the LAN cable or Local Area Network cable common in the computer industry. Such cables typically include one or more twisted pairs of cables, one or more additional components such as separators, shields, drain wires etc. . . . and a jacket around the components. LAN cables can come in many sizes based on the pair count, but for the purposes of illustration the present application, the present examples use the common 4-pair LAN cable used for network communication such as the one pictured in prior art FIG. 1 (shown with optional cross-filler).

When constructing the cables careful attention is paid to the construction of each component in order to not only maintain the desired electrical characteristics but also to meet the various mechanical and fire safety standards. For example, LAN cables need to meet certain electrical characteristics such as those set forth in the CAT 5, CAT 5e, CAT 6, etc. . . . (setting for example allowable insertion loss, return loss and crosstalk requirements for 100 ohm impedance cable) based on the TIA 568C.2 industry standard.

While meeting those electrical standards, these same LAN cables also need to meet certain physical requirements such as cold bend, insulation elongation, and tensile requirements as set forth in the UL 444 industry standard.

Moreover, LAN cables also need to meet fire and smoke tests such as those outlined in NFPA 262/UL 910, UL1666 and UL1685 depending on listing type.

In order to meet these requirements, regarding the insulation used on the twisted pairs, LAN cable producers often use FEP (Fluorinated Ethylene Propylene) because it not only has excellent electrical properties but also has both good mechanical properties and fame/smoke resistance. However, FEP is expensive and it is halogenated and there is generally a desire to reduce harmful halogens in cables owing to environmental and health concerns.

In order to avoid the use of FEP some prior art solutions use fire/smoke resistant PE (Polyethylene), PP (Polypropylene), and PVC (Poly Vinyl Chloride) for the pair insulation because they are less expensive than FEP. However, these polymers require fillers and modifications to enhance their smoke/fire resistance properties which negatively affect their mechanical and electrical properties, causing these properties to be worse than FEP. For example, some flame retardant fillers could include MDH (Magnesium Hydroxide Flame Retardants) or ATH (alumina trihydrate), boron containing compounds, brominated compounds, and molybdenum compounds, etc. . . . . However, these fillers have issues with affecting the dielectric properties or generating a great deal of smoke during their combustion in olefins.

There are additional prior art solutions that employ fire retardant phosphorus containing compounds. Such solutions often employ them in polyolefins, for example EVA (ethylene vinyl acetate) or other flexible polymers (instead of within ordinary modified PP (polypropylene) composites used with more typical inorganic fillers). Also due to high loading of phosphorus to achieve flame retardancy, the electrical properties of the resulting material (both PP/PE and EVA materials) is outside of the range used in data cables (i.e. dielectric constant and dissipation factor too high). Furthermore, there is a diminishing return when adding phosphorus into the material to where above a certain loading percentage there is negligible increase in flame retardancy but a large increase in negative electrical properties.

### OBJECTS AND SUMMARY

The present arrangement provides a novel fire resistant material for use in data communication cables that employs a combination of phosphorus containing compound additives with organo-titanates additives, together added to a thermoplastics polyolefin (TPO) base. The combination of the phosphorus containing compounds with the organo-titanates provides a synergistic effect that greatly increases the fire resistant properties of the base polyolefin compound without using as much of the phosphorus containing compounds. Additionally, the addition of a small amount of silica powder (either amorphous, submicron sized, fumed, etc.) further enhances the fire resistance properties of the TPO compound without significantly affecting the mechanical properties.

To this end, the present arrangement provides a material used for insulation within a data communication cable, the material having a base polymer, a phosphorus containing additive, an organo-titantate additive, and silica material (fumed, precipitated, etc).

### BRIEF DESCRIPTION OF THE DRAWINGS

The present invention can be best understood through the following description and accompanying drawings, wherein:

FIG. 1 illustrates a prior art LAN cable; and

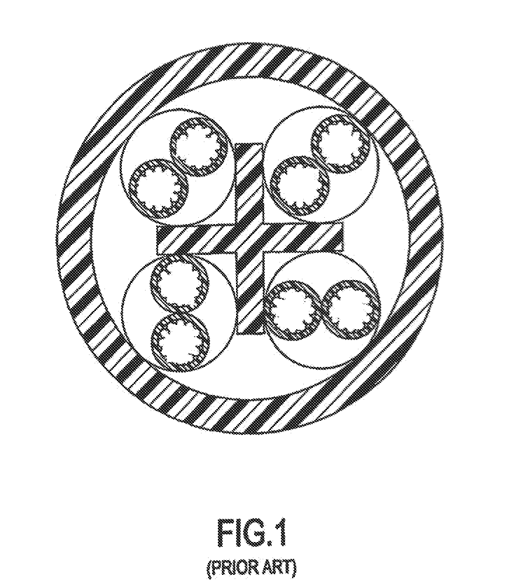

FIG. 2 illustrates a LAN cable according to one embodiment.

### DETAILED DESCRIPTION

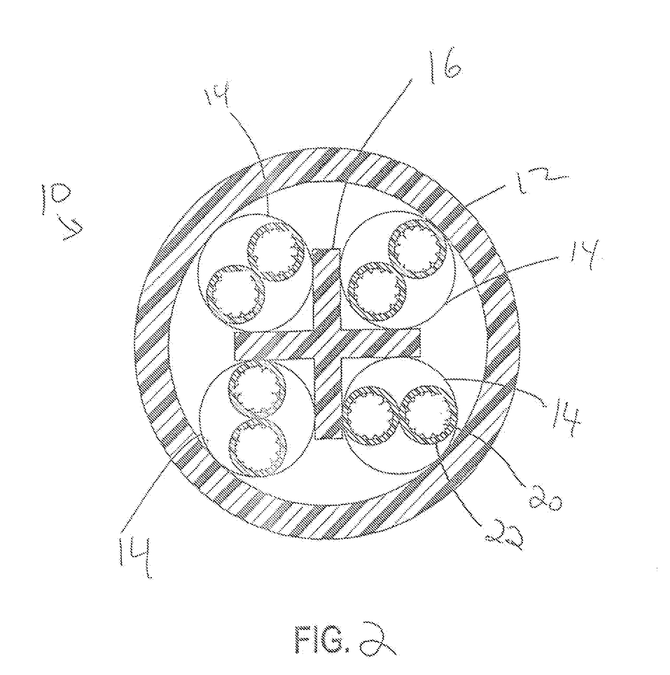

The present arrangement as illustrated for example in FIG. 2 is directed to a LAN cable 10 having a jacket 12, four twisted pairs of conductors (pairs) 14 and optional separator 16. Each of twisted pairs 14 are made from two twisted conductors 20, each of which has an insulation 22 thereon. It is understood that such components are exemplary and are in no way intended to limit the scope of the present invention. Cable 10 may have more or less than four (4) twisted pairs 14. Additionally, cable 10 may have additional components (not shown) such shielding, ground wires, binders etc. . . . .

In the present arrangement, insulation 22 on each of conductors 20 is made from polyolefin insulation including a combination of a phosphorus containing additive, nitrogen complex, and an organo-titanate. This configuration can also include a silica powder (either fumed, precipitated, coated, sub-micron, etc.) and/or a silica grafted silicone polymer for drip resistance and enhanced char characteristics.

In a preferred embodiment, insulation 22 is made from a thermoplastic polyolefin (TPO) base however, other polyolefin base polymers may be used such as typical polyolefins used in data communication cables including PP (polypropylene), impact modified PP, HDPE (high density polyethylene), LDPE (low density polyethylene), ethylene-octene copolymers, POE (Polyolefin elastomer), etc. . . . . This list is intended to be exemplary; other similar olefin based polymers may be used as the base polymer for insulation 22.

The phosphorus containing additive is ideally selected from ammonium polyphosphate, melamine polyphosphate, piperazine pyrophosphate and aluminum tris-(diethylphosphinate), however, other phosphate-based fire retardant additives may be used. These phosphorus materials may also be combined with a nitrogen complex either grafted to the material or mixed with the materials. The nitrogen containing compound may be used to act as a “blowing agent” that gives rise to the intumescence, which is the property of swelling under certain conditions.

The organo-titanates are ideally selected from:
Titanium IV 2,2(bis 2-propenolatomethyl)butanolato, tris neodecanoato-O;
Titanium IV 2,2(bis 2-propenolatomethyl)butanolato, iris(dodecyl)benzenesulfonato-O;
Titanium IV 2,2(bis 2-propenolatomethyl)butanolato, tris(dioctyl)phosphato-O;
Titanium IV 2,2(bis 2-propenolatomethyl)butanolato, tris(dioctyl)pyrophosphato-O;
Titanium IV 2,2(bis 2-propenolatomethyl)butanolato, tris(2-ethylenediamino)ethylato;
Titanium IV 2,2(bis 2-propenolatomethyl)butanolato, tris(3-amino)phenylato; and
Titanium IV 2,2(bis 2-propenolatomethyl)butanolato, tris(6-hydroxy)hexanoato-O.

It is noted that the above list is not considered exhaustive and other organo titianates or organo zirconates may be used as well.

In one embodiment, the composition may further employ a silica agent or silica powder to further enhance the fire resistance properties. Such silica powders are ideally selected from any one of the following: fumed silica, precipitated silica, silica grafted silicone polymer, amorphous silica, and sub-micron silica. It is noted that the above list is not considered exhaustive, and other silica materials may be used as well.

Such an arrangement provides a distinct advantage over prior art solutions. Many of the phosphorus containing additives above have an intumescent property that makes them good at providing fire resistance. This intumescence results in a char “foam” that insulates the polymer underneath from the flame. This causes a reduction in heat seen by the polymer under the char foam resulting in slower burning of the underlying material. When such intumescent flame retardants are added, the flame properties of thermoplastics polyolefin (TPO), such as the polypropylene, ethylene propylene copolymer, ethylene alpha-olefin copolymers, ethylene octane copolymers, and polyethylene increase dramatically.

In the prior art discussed above, normally phosphorus containing additives are added at 1-50% by weight resulting compound with higher dielectric properties preventing their use as insulation material for LAN cables. However, in the present arrangement, with the addition of the organo-titanates to the phosphorus containing additives, the amount of phosphorus containing additives does not need to be as high to achieve the same fire resistance and keeping the dielectric properties suitable for LAN cables.

The benefits of the organo-titanates are three fold. The first is the increase in dispersion of the phosphorus and nitrogen complex filler within the polymer base improving the effectiveness of the phosphorus. These titanates also contain nano-scale phosphorus, giving rise to enhanced fire properties due to the pyrolysis of this phosphorus. Finally the titanates can remove water from the surface of the coated phosphorus and nitrogren complex. Water decreases the effectiveness of phosphorus systems and causes a reduction in fire performance. As such with an addition of 0.1-4% of the organo-titanates, the flame retardation of the polymer composite increases much farther than adding just 0.1-4% extra intumescent phosphorus based flame retardant.

For example, because of this synergistic effect, in the present case using 20-40% (range) phosphorus/N2 complex, and 0.1-4% (range) organo-titanate and polyolefin 56-79% the same amount of flame resistance can be achieved as adding 45% phosphorus with 55% polyolefin while maintaining much better electrical properties compared to the 45% phosphorus material. As such, various flame/smoke tests such as NFPA 262/UL 910, UL1666 and UL1685, employed in the data communications cable industry can be passed using less additives, and thus without overly degrading the mechanical properties of the polyolefin and without resorting to the expensive and halogen containing polymers such as FEP. As an additional benefit the reduction in flame resistant phosphorus additive loading of the polymer base also enhances melt processing of the compound during the extrusion/fabrication process of insulation 22.

Illustrating on exemplary formulation, the following table 1 shows a polymer composition (ranges and a specific example) for making insulation 22.

TABLE 1

| | Range, | Example, |
|---|---|---|
| Materials | Weight % | Weight % |
| Thermoplastics Polyolefin (TPO) | 38-89.6% | 68.45% |
| Piperazine pyrophosphate/Nitrogen | 10-40% | 28.3% |
| complex | | |
| Organotitanate | 0.1-5% | 0.375% |
| Silica powder | 0.1-3% | 0.175% |
| Silica grafted silicone polymer | 0.1-10% | 2% |
| (Silica/Silicon polymer complex) | | |
| Stabilizer | 0.1-4% | 0.35% |

| Properties | Results |
|---|---|
| LOI | 34 |
| Dripping | No |
| Char Integrity | Excellent |

The end of Table 1 shows that the present example when tested provides good char integrity and does not drip when burned and also maintains a good LOI (limited oxygen index) test result.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

1. A material used for insulation within a data communication cable, said material comprising:
a base polymer;
a phosphorus containing additive; and
an organo-titantate additive.

2. The material as claimed in claim 1, wherein said material is applied to the conductors of said data communication cable.

3. The material as claimed in claim 1, wherein said material is applied as a jacket to said data communication cable.

4. The material as claimed in claim 1, wherein said material is applied as a filler element within said data communication cable.

5. The material as claimed in claim 1, wherein the base polymer is a polyolefin.

6. The material as claimed in claim 5, wherein the polyolefin is selected from the group consisting of thermoplastic polyolefin (TPO), PP (polypropylene), ethylene-Propylene copolymer, impact modified PP, POE (polyolefin elastomer, HDPE (high density polyethylene), ethylene-octene copolymer, and LDPE (low density polyethylene).

7. The material as claimed in claim 1, wherein the phosphorus containing additive is selected from the group consisting of ammonium polyphosphate, melamine polyphosphate, piperazine pyrophosphate and aluminum tris-(diethylphosphinate).

8. The material as claimed in claim 7, wherein said phosphorus containing additive further includes a nitrogen complex either one of graphed to the material or mixed with the material, said nitrogen complex providing an intumescence property.

9. The material as claimed in claim 7, wherein said phosphorus containing additive is included as 10-40% weight of the material.

10. The material as claimed in claim 1, wherein said organo-titanate is selected from the group consisting of:
Titanium IV 2,2(bis 2-propenolatomethyl)butanolato, tris neodecanoato-O;
Titanium IV 2,2(bis 2-propenolatomethyl)butanolato, iris(dodecyl)benzenesulfonato-O;
Titanium IV 2,2(bis 2-propenolatomethyl)butanolato, tris(dioctyl)phosphato-O;
Titanium IV 2,2(bis 2-propenolatomethyl)butanolato, tris(dioctyl)pyrophosphato-O;
Titanium IV 2,2(bis 2-propenolatomethyl)butanolato, tris(2-ethylenediamino)ethylato;
Titanium IV 2,2(bis 2-propenolatomethyl)butanolato, tris(3-amino)phenylato; and
Titanium IV 2,2(bis 2-propenolatomethyl)butanolato, tris(6-hydroxy)hexanoato-O.

11. The material as claimed in claim 1 wherein said organo-titanate is included as 0.1-5% weight of the material.

12. The material as claimed in claim 1 wherein said material further comprises 0.1-5% weight of any one of silica powder and a silica/silicon polymer complex.
